(19) United States
(12) Patent Application Publication
(10) Pub. No.: US 2015/0343345 A1
(43) Pub. Date: Dec. 3, 2015

(54) FUEL FILTER FOR DIESEL ENGINE

(71) Applicants: Hyundai Motor Company, Seoul (KR); Kia Motors Corporation, Seoul (KR)

(72) Inventors: Dongmyoung RYOO, Yongin-Si (KR); Sunghwan CHI, Seongnam-Si (KR); Seungyup OH, Hwaseong-Si (KR); Changho HAM, Ansan-Si (KR); Pilseon CHOI, Anyang-Si (KR); Buyeol RYU, Hwaseong-Si (KR); Sangpil BYUN, Hwaseong-Si (KR); Taeho HAN, Hwaseong-Si (KR); Giwon PARK, Hwaseong-Si (KR)

(73) Assignees: Hyundai Motor Company, Seoul (KR); Kia Motors Corporation, Seoul (KR)

(21) Appl. No.: 14/557,116

(22) Filed: Dec. 1, 2014

(30) Foreign Application Priority Data
May 29, 2014 (KR) 10-2014-0065258

(51) Int. Cl. B01D 35/00

(52) U.S. Cl. CPC B01D 35/005

(57) ABSTRACT

A fuel filter for a diesel engine may include a head cover, a housing which is engaged to the head cover and accommodates a filter assembly, a body which passes through the head cover and is disposed at the center of the filter assembly, and a heater assembly which is disposed inside of the body, in which the housing is integrally engaged with an engine body, and the heater assembly selectively operates depending on a detection signal of a fuel temperature sensor provided at the engine body.

### CROSS-REFERENCE TO RELATED APPLICATION

The present application claims priority to Korean Patent Application No. 10-2014-0065258 filed May 29, 2014, the entire contents of which is incorporated herein for all purposes by this reference.

### BACKGROUND OF THE INVENTION

1. Field of the Invention

The present invention relates to a fuel supply system for a diesel engine, and more particularly, to a fuel filter for a diesel engine for filtering diesel fuel supplied from a fuel tank to a diesel engine.

2. Description of Related Art

The diesel fuel filter is generally installed with a diesel fuel supply system which is configured to supply diesel fuel stored in a fuel tank to a diesel engine.

The diesel fuel filter filters diesel fuel supplied from the fuel tank to the diesel engine. Here, impurities contained in the diesel engine are filtered, and the fuel is heated to prevent the diesel fuel from coagulating. Water contained in the diesel fuel is separated and discharged to the outside.

Such a diesel fuel filter basically includes a housing, a filter cartridge housed in the housing, a head cover engaged to the top of the housing, and a heater installed between the filter cartridge and the head cover.

In addition, the diesel fuel filter further includes a thermo switch installed at the head cover side and supplying a switching signal to the heater depending on the temperature of the diesel fuel, a water sensor detecting the level of the water stored in the housing, and a drain plug installed at a lower side of the housing and configured to discharge the water from the interior of the housing.

Meanwhile, the diesel fuel filter is generally installed at a vehicle body through a mounting unit. For example, the head cover side is disposed on the top of a cowling panel, and the housing side is disposed at the side of a brake booster.

However, since a conventional diesel fuel filter configured above is installed in the vehicle body, the diesel fuel filter may be easily damaged by impact force when an offset collision occurs, it is hard to set the layout during a designing procedure, and assembling workability and repair performance have drawbacks due to the neighboring components.

Further, in order to operate the heater, the conventional diesel fuel filter needs to provide a thermo switch which supplies a switching signal to the heater depending on the temperature of the diesel fuel, and as a result, the whole structure becomes complicated, assembly defects may be caused due to an increase in the number of assembling components, and the manufacturing cost and the weight may increase.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a fuel filter for a diesel engine which may be integrally constituted with the engine so as to improve collision safety, assembling workability, and repair performance.

Further, various aspects of the present invention are directed to providing a fuel filter for a diesel engine which may eliminate a thermo switch by controlling the operations of a heater using a fuel temperature sensor at the side of the engine.

According to various aspects of the present invention, a fuel filter for a diesel engine may include a head cover, a housing engaged to the head cover and configured to house a filter assembly, a body which passes through the head cover and is disposed at the center of the filter assembly, and a heater assembly disposed inside of the body, in which the housing may be integrally engaged to an engine body. and the heater assembly may be selectively operated based on a detection signal of the fuel temperature sensor provided in the engine body.

The fuel filter for a diesel engine may further include a water sensor which is disposed at the body and configured to detect a level of the water separated from diesel fuel.

The body may separately form a fuel passage connected to the filter assembly and a water drain passage connected to a bottom of an inner side of the housing.

The heater assembly may be installed at the fuel passage, and the water sensor may be installed at the water drain passage.

A water discharge port may be formed at a top of the body and connected to the water drain passage, and a drain plug may be installed at the water discharge port.

The body may pass through the head cover and is engaged with the head cover, and a top of the body may be disposed on an upper surface of the head cover.

According to various aspects of the present invention, a fuel filter for a diesel engine may include a head cover, a housing which is integrally engaged with an engine body and engaged to the head cover and accommodates a filter assembly, a body separately forming a fuel passage which passes through the head cover and is installed at a center of the filter assembly and partitions the filter assembly and a water drain passage connected to a bottom of an inner side of the housing, a heater assembly which is installed at the fuel passage of the body, a water sensor which is installed at the water drain passage of the body and is configured to detect the level of water separated from diesel fuel, and a water discharge unit which is disposed at a top of the body so as to discharge the water input into the water drain passage.

The body may be integrally formed with the heater assembly, the water sensor, and the water discharge unit as a single module structure.

An engaging portion which supports the heater assembly and the water sensor and forms the water discharge unit may be provided at the top of the body.

The head cover may include a fuel inflow nipple configured to enable the diesel fuel to flow into the filter assembly, and a fuel discharge nipple which discharges the diesel fuel from water and impurities which are removed through the filter assembly.

The body may separately form, at a hollow portion of an inside of the body, a fuel passage and a water drain passage each having a semi-circular cross-section and formed through a partition wall.

The heater assembly may include a pair of heat dissipation plates installed at the fuel passage, and a plurality of Positive Temperature Coefficient (PTC) devices which are arranged between the pair of the heat dissipation plates and engaged to the heat dissipation plates using engaging bolts.

The PTC devices may be arranged in a zigzag shape in a longitudinal direction of the heat dissipation plates.

Both ends of each heat dissipation plate in the longitudinal direction of the body may be bent toward an inner wall surface of the fuel passage.

An engaging portion which supports the heater assembly and the water sensor and forms the water discharge unit may be provided at the top of the body, and a connector which is connected to the PTC devices as an electric signal system may be installed at the engaging portion.

The water sensor may include a circuit substrate installed at the engaging portion, and at least one sensor pin which is connected to the circuit substrate and fixed at the engaging portion, and disposed at the water drain passage.

The water discharge unit may include a water discharge port which is formed at the top of the body and connected to the water drain passage, and a drain plug which is installed at the water discharge port.

An engaging portion which supports the heater assembly and the water sensor and forms the water discharge unit may be provided at the top of the body, and the water discharge port may be integrally formed at the engaging portion.

A sealing cap which passes through a water input portion connected to the water drain passage and seals the fuel passage may be installed at a bottom of the body.

The heater assembly may selectively operate according to a detection signal of the fuel temperature sensor disposed at the engine body.

The various embodiments of the present invention are integrally engaged with the engine body using the mounting bracket, such that the fuel filter cannot be damaged due to impact force during an offset collision of the vehicle, thereby enhancing collision safety and collision performance.

In various embodiments of the present invention, since the heater assembly and the water discharge unit are integrally configured as a single module structure at the top of the body, the whole structure is simplified, and the size may be compactly implemented.

Further, the fuel filter for a diesel engine according to various embodiments of the present invention is integrally constituted with the engine body, and the water discharge unit is provided at the top of the body, and as a result, the assembling workability of the whole apparatus may be enhanced, and since the water discharging operation may be performed at the water discharge unit, the repairing performance may be enhanced.

Furthermore, in the fuel filter for a diesel engine according to various embodiments of the present invention, the operations of the heater assembly may be controlled by the controller such as an engine ECU by using the fuel temperature sensor which is pre-installed at the engine body, and as a result, an existing thermo switch may be eliminated.

Therefore, in various embodiments of the present invention, since the existing thermo switch may be eliminated, the structure of the whole apparatus may be simplified, and the number of assembling parts may be reduced, thereby decreasing an assembling defect ratio, manufacturing cost, and weight.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating an exemplary fuel filter for a diesel engine according to the present invention.

FIG. 2A is a disassembled perspective view illustrating the exemplary fuel filter for the diesel engine according to the present invention.

FIG. 2B is a disassembled perspective view illustrating part of the exemplary fuel filter for the diesel engine according to the present invention.

FIG. 3 is a view illustrating a cross-sectional configuration of the exemplary fuel filter for the diesel engine according to the present invention.

FIG. 4A, FIG. 4B, and FIG. 4C are views illustrating a body which is applied to the exemplary fuel filter for the diesel engine according to the present invention.

FIG. 5A, FIG. 5B, FIG. 5C, FIG. 5D and FIG. 5E are views illustrating a heater assembly which is applied to the exemplary fuel filter for the diesel engine according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

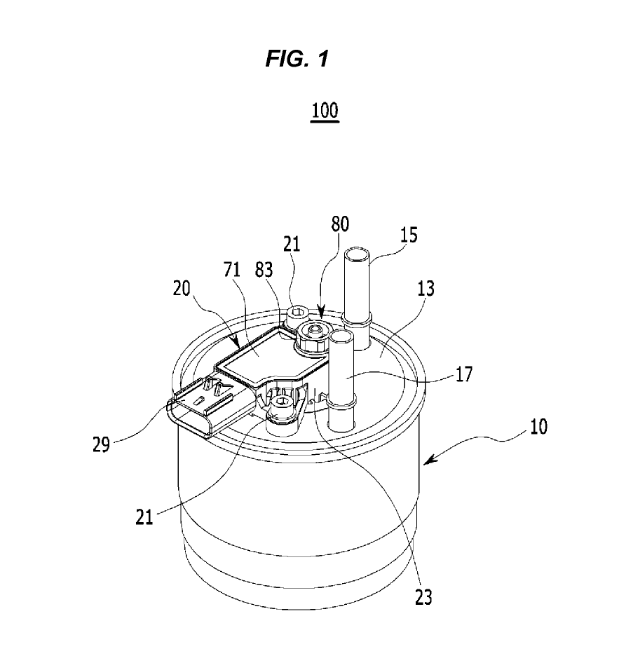

FIG. 1 is a perspective view illustrating a fuel filter for a diesel engine according to various embodiments of the present invention.

Referring to FIG. 1, a fuel filter 100 for a diesel engine according to various embodiments of the present invention may be applied to a diesel fuel supply system for supplying diesel fuel stored in a fuel tank to a diesel engine.

The fuel filter 100 for a diesel engine according to various embodiments of the present invention filters the diesel fuel (hereinafter referred to as “fuel” for convenience) supplied from the fuel tank to the diesel engine.

Such a fuel filter 100 for a diesel engine serves to filter impurities contained in the fuel, heat the fuel so as to prevent any coagulation of the fuel during the winter season, and separate water contained in the fuel to discharge the separated water to the outside.

The fuel filter 100 for a diesel engine according to various embodiments of the present invention is integrally constituted with the engine so as to improve collision safety, assembling workability, and repairing performance, and is constituted in a structure in which a thermo switch may be eliminated by controlling the operation of the heater using a fuel temperature sensor of the engine side.

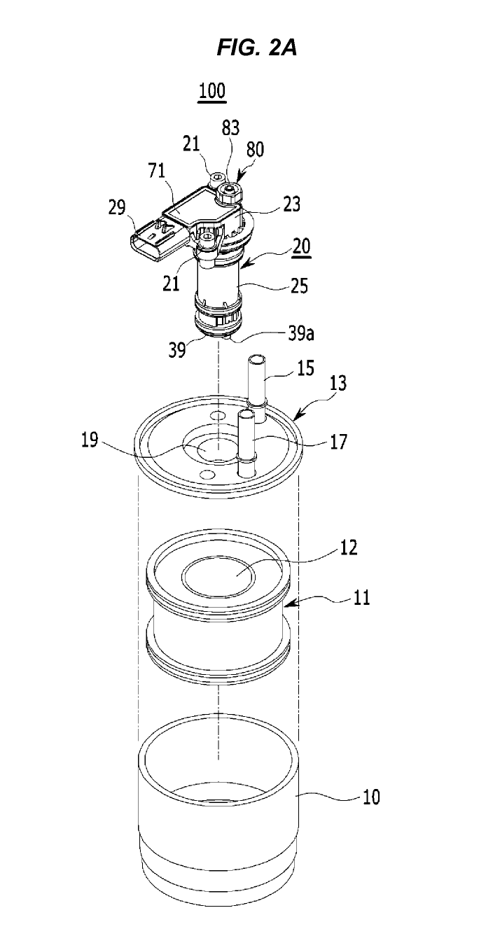

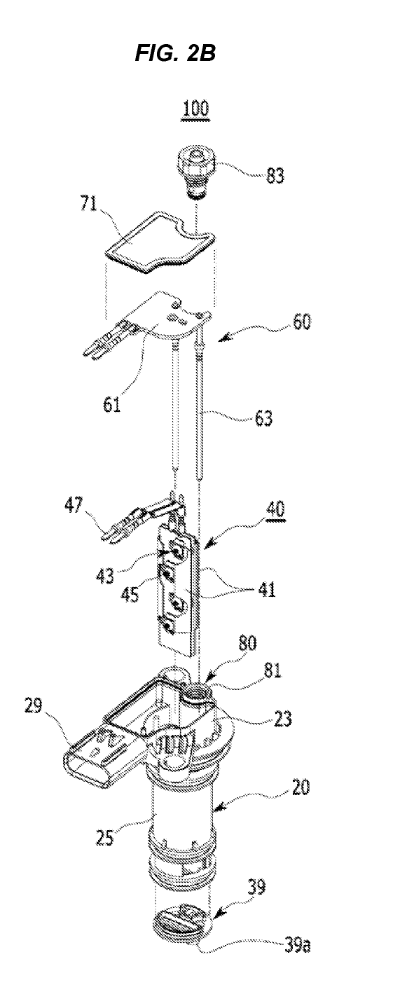

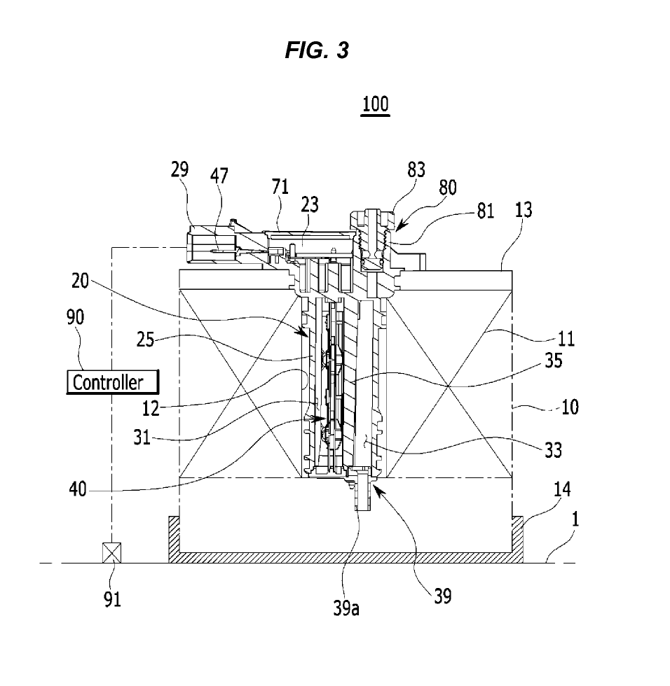

FIG. 2A is an exploded perspective view illustrating the fuel filter for a diesel engine according to various embodiments of the present invention, FIG. 2B is an exploded perspective view illustrating a part of the fuel filter for a diesel engine according to various embodiments of the present invention, and FIG. 3 is a view illustrating a cross-section configuration of the fuel filter for a diesel engine according to various embodiments of the present invention.

Referring to FIG. 1, FIG. 2A, FIG. 2B and FIG. 3, the fuel filter 100 for a diesel engine according to various embodiments of the present invention basically includes a housing 10, a body 20, a heater assembly 40, a water sensor 60, and a water discharge unit 80.

In various embodiments of the present invention, the housing 10 has a shape of a container which has an inner space, is opened at the upper end, and is closed at the lower end thereof.

In the inner space of the housing 10, a filter assembly 11 is engaged so as to filter fuel. The filter assembly 11 forms a hollow portion 12 connected to the inner space of the housing 10 at the center.

Such a filter assembly 11 is formed of a filter cartridge of a conventional diesel fuel filter apparatus which is widely known in the art, and as a result, the detailed descriptions thereof will be omitted in this specification.

Here, a head cover 13 is engaged to the top of the housing 10 so as to cover the top. The head cover 13 includes a fuel inflow nipple 15 for inputting the fuel into the filter assembly 11, and a fuel discharge nipple 17 for discharging the fuel from which impurities and water are removed through the filter assembly 11.

In addition, an insertion hole 19 connected to the hollow portion 12 of the filter assembly 11 is formed at the center of the head cover 13. The insertion hole 19 is used to install the body 20 to be described below in detail on the housing 10.

Meanwhile, the housing 10 may store the water separated from the fuel through the filter assembly 11 at the inner bottom thereof.

In addition, the housing 10 is integrally mounted on a main body 1 (hereinafter referred to as an “engine body” for convenience) of the engine in various embodiments of the present invention. For example, the lower surface of the housing 10 may be engaged to the engine body 1. In this case, the housing 10 may be fixedly installed at the engine body 1 through a mount bracket 14.

In various embodiment of the present invention, the body 20 is integrally configured by the heater assembly 40, the water sensor 60, and the water discharge unit 80, which will be described below in detail, as a single module structure. The body 20 may pass through the insertion hole 19 of the head cover 13 and may be installed at the hollow portion 12 of the filter assembly 11.

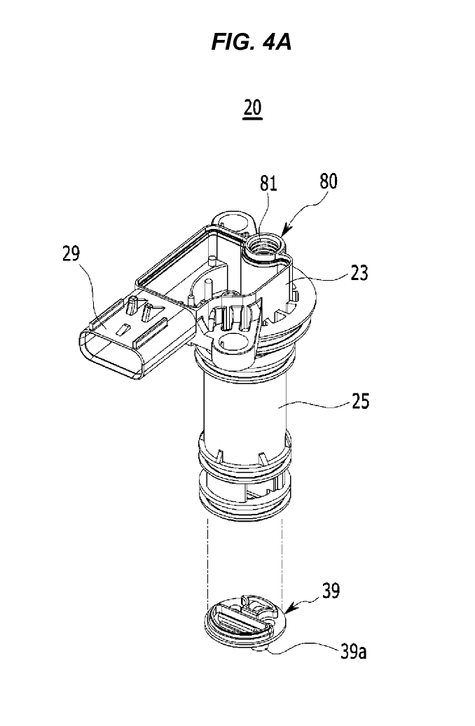

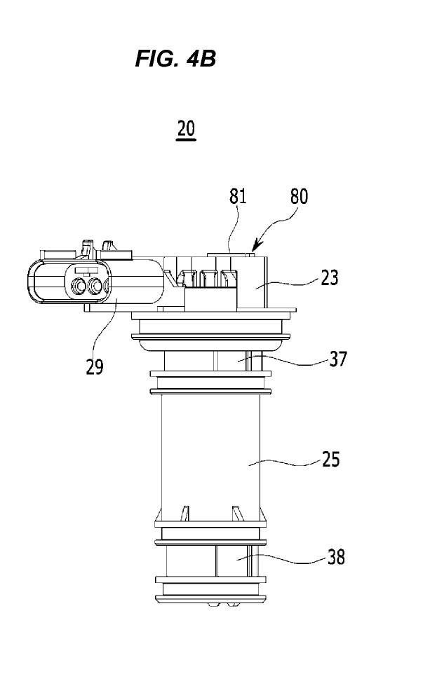

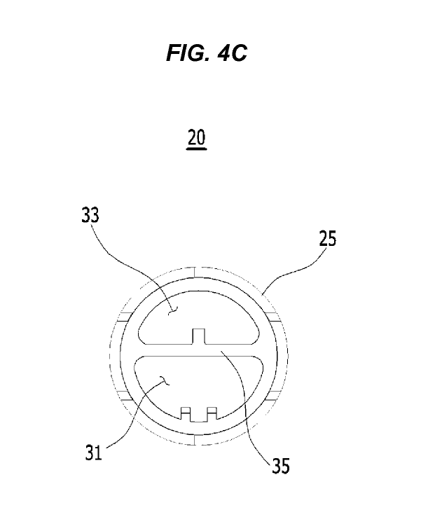

FIG. 4A, FIG. 4B, and FIG. 4C are diagrams illustrating a body which is applied to the fuel filter for a diesel engine according to various embodiments of the present invention.

Referring to FIG. 4A, FIG. 4B, and FIG. 4C in addition to FIG. 1, FIG. 2A, FIG. 2B, and FIG. 3, the body 20 according to various embodiments of the present invention may pass through the insertion hole 19 of the head cover 13 and be engaged to the head cover 13 through an engaging device 21 such as a bolt in a state that the body 20 is disposed at the hollow portion 12 of the filter assembly 11.

Here, the top of the body 20 supports an edge of the insertion hole 19 and is disposed on the upper surface of the head cover 13. An engaging unit 23 to be described below that supports the heater assembly 40 and the water sensor 60 and forms the water discharge unit 80 is formed at the top of the body 20.

Such a body 20 extends downward from the engaging unit 23, and partitions and separately forms a fuel passage 31 and a water drain passage 33 at a portion (hereinafter referred to as “an extension 25” for convenience) disposed to the hollow portion 12 of the filter assembly 11.

The fuel passage 31 and the water drain passage 33 are partitioned and formed at the inner hollow portion of the extension 25 in a longitudinal direction, the fuel passage 31 is connected to the filter assembly 11 and forms a fuel stream, and the water drain passage 33 is connected to the inner bottom of the housing 10 and forms a water draining stream.

Here, a partition wall 35 is formed at the inner hollow portion of the extension 25 so as to separately form the fuel passage 31 and the water drain passage 33. The fuel passage 31 and the water drain passage 33 may each be formed as a passage with a semicircular cross-section because of the partition wall 35.

In addition, a fuel inlet 37 and a fuel outlet 38 which are connected to the fuel passage 31 are formed at upper and lower sides of the extension 25 of the body 20, respectively.

The fuel inlet 37 flows the fuel inputted through the fuel inflow nipple 15 of the head cover 13 into the fuel passage 31, and the fuel outlet 38 flows the fuel which has passed through the fuel passage 31 into the filter assembly 11.

Meanwhile, the water drain passage 33 is connected to the water discharge unit 80 to be described below in detail and formed to be separated from the fuel passage 31 by the partition wall 35 at the inner hollow portion of the extension 25, and serves to flow the water stored at the inner bottom of the housing 10 to the water discharge unit 80.

In the extension 25, the top of the fuel passage 31 is closed by the engaging unit 23 as described above, and the top of the water drain passage 33 may be opened by means of the water discharge unit 80.

In addition, a sealing cap 39 is engaged to the bottom of the extension 25 so as to seal the bottoms of the fuel passage 31 and the water drain passage 33. The sealing cap 39 passes through a water inflow port 39a connected to the water drain passage 33 and closes the fuel passage 31.

In various embodiments of the present invention, the heater assembly 40 prevents the coagulation of fuel during the winter season by heating the fuel inputted through the fuel inflow nipple 15 of the head cover 13 into the fuel passage 31.

Such a heater assembly 40 generates heat by receiving predetermined electric power, and is installed at the fuel passage 31 of the body 20.

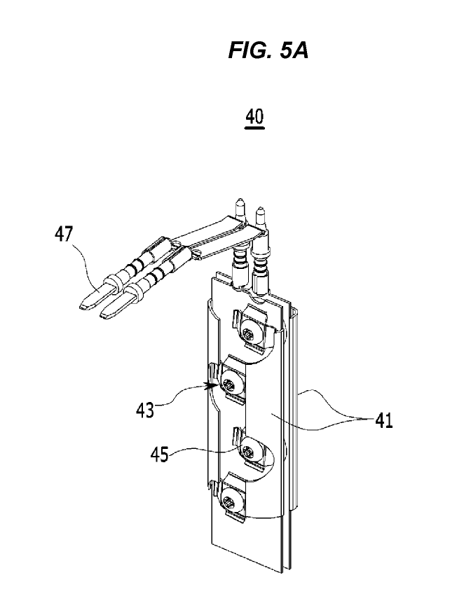

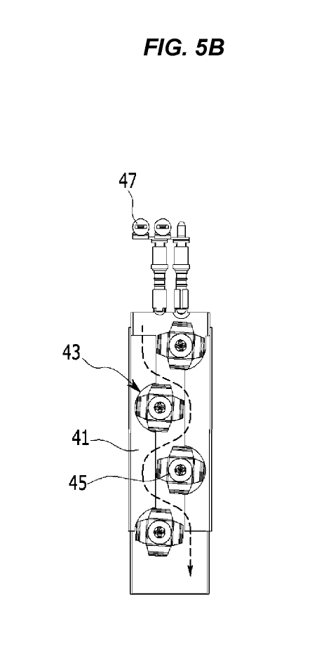

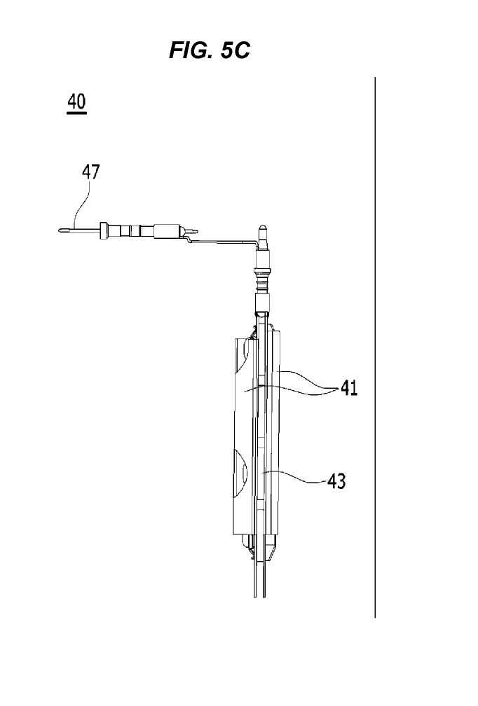

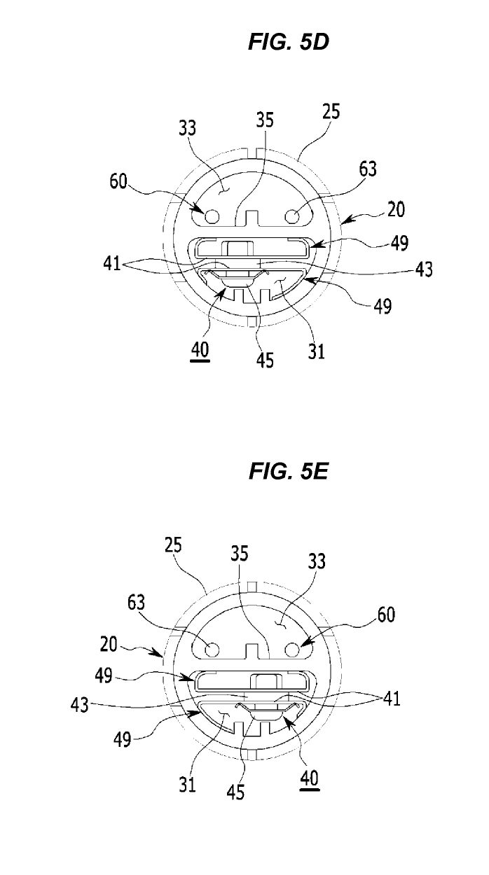

FIGS. 5A, 5B, and 5C are diagrams illustrating a heater assembly which is applied to the fuel filter for a diesel engine according to various embodiments of the present invention.

Referring to FIG. 5A, FIG. 5B, FIG. 5C, FIG. 5D and FIG. 5E in addition to the drawings illustrated above, the heater assembly 40 according to various embodiments of the present invention is installed inside the body 20, and at the fuel passage 31 of the body 20 thereof. Such a heater assembly 40 includes a pair of heat dissipation plates 41 and a plurality of Positive Temperature Coefficient (PTC) devices 43.

Here, the heat dissipation plates 41 are made from a metallic material which can easily radiate heat and are installed inside of the fuel passage 31 of the body 20. The heat dissipation plates 41 may be fixedly installed at the inner wall surface of the fuel passage 31.

In addition, the PTC devices 43 receive power to generate heat. The PTC devices 43 are disposed between the pair of heat dissipation plates 41 so as to transfer heat to the heat dissipation plates 41, and may be engaged to the heat dissipation plates 41 through an engaging bolt 45.

Such PTC devices 43 are formed of semiconductor devices, and serve to generate heat when a current of a predetermined level or more flows and generate heat with a predetermined temperature by blocking the current when electric resistance is increased when the temperature reaches a switching temperature by self-heat dissipation.

Here, the PTC devices 43 are continuously arranged at regular intervals in a longitudinal direction of the heat dissipation plates 41. In various embodiments of the present invention, the PTC devices 43 may be arranged in a zigzag shape in the longitudinal direction of the heat dissipation plates 41.

The reason why the PTC devices 43 are arranged in the zigzag shape in the longitudinal direction of the heat dissipation plates 41 is that the heat transfer area of the fuel for the heat dissipation plates 41 may thereby be increased, and the stream length (the length of the flow passage) of the fuel flowing along the fuel passage 31 may be increased.

In addition, the PTC devices 43 are connected to connection terminals 47 which supply the power and an electric signal of a signal system. Such connection terminals 47 are disposed at the engaging unit 23 of the body 20 as described above in a state in which the connection terminal 47 is connected to the PTC devices 43. In this case, the connection terminals 47 are connected to a connector 29 of the engaging unit 23 as an electrical signal system.

Meanwhile, in various embodiments of the present invention, ends of both edges of each of the heat dissipation plates 41 in the longitudinal direction of the body 20 include a bent portion 49 which is elastically bent toward an inner wall surface of the fuel passage 31.

The bent portion 49 serves to fix the heat dissipation plate 41 to an inner wall surface of the fuel passage 31 through elastic restoring force, and also serves to guide the fuel which flows along the fuel passage 31.

In addition, the reason why the bent portion 49 is formed at the ends of both edges of each of the heat dissipation plates 41 is that a contact area (a heat transfer area) of the fuel which flows along the fuel passage 31 with respect to the heat dissipation plates 41 is increased.

In another aspect, the heat assembly 40 according to various embodiments of the present invention may be selectively operated according to a detection signal of a fuel temperature sensor 91 which is pre-installed at the engine body 1.

In addition, the PTC devices 43 receive the power and the electrical signal system through a controller 90, and the fuel temperature sensor 91 detects the temperature of the fuel and outputs the detection signal to the controller 90.

The controller 90 receives the detection signal from the fuel temperature sensor 91 and compares the detection signal with a predetermined reference temperature range of the fuel. When the temperature of the fuel is lower than the reference temperature range, the power and the electrical operation signal may be supplied to the PTC devices 43.

Referring to FIG. 5D and FIG. 5E in addition to FIG. 2A, FIG. 2B, and FIG. 3 illustrated above, the water sensor 60 in various embodiments of the present invention is separated from the fuel through the filter assembly 11 to detect the level of water stored at the bottom of the inner side of the housing 10.

The water sensor 60 is installed at the water drain passage 33 of the body 20, and includes a circuit substrate 61 installed at the engaging unit 23 of the body 20 and a pair of sensor pins 63 connected to the circuit substrate 61.

The circuit substrate 61 may apply a detection source such as electrical resistance to the sensor pins 63 and output a detection signal detected by the sensor pins 63 to the controller 90.

Such a circuit substrate 61 is installed at the engaging unit 23 of the body 20, and may be connected to the connector 29 of the engaging unit 23 as an electrical signal system described above separately from the connection terminals 47 of the PTC devices 43.

In addition, the sensor pins 63 detect the level of the water stored at the bottom of the inner side of the housing 10 through the electrical resistance, and the sensor pins 63 are electrically connected to the circuit substrate 61 while fixed at the engaging unit 23 of the body 20 and disposed inside of the water drain passage 33.

That is, the sensor pins 63 may detect the level of the water stored at the bottom of the inner side of the housing 10 and inputted into the water drain passage 33 through the water inflow port 39a of the sealing cap 39.

In the drawings, the reference numeral 71 which is not described represents a body cover for covering the engaging unit 23 which accommodates the connection terminals 47 of the PTC devices 43 and the circuit substrate 61 of the water sensor 60. Such a body cover 71 may be engaged to the open end of the top of the engaging unit 23 (refer to FIG. 2A and FIG. 2B).

Referring to FIG. 1, FIG. 2A, FIG. 2B and FIG. 3 illustrated above, the water discharge unit 80 according to various embodiments of the present invention is configured to discharge water which is separated from the fuel through the filter assembly 11 and inputted into the water drain passage 33 of the body 20 while being stored at the bottom of the inner side of the housing 10.

The water discharge unit 80 is disposed at the top of the body 20. More specifically, the water discharge unit 80 includes a water discharge port 81 formed at the top of the body 20, and a drain plug 83 installed at the water discharge port 81.

The water discharge port 81 is integrally formed at the engaging unit 23 of the body 20 and may be connected to the water drain passage 33. The drain plug 83 may include a drain bolt engaged to the water discharge port 81 and opening and closing the water discharge port 81.

That is, when the water sensor 60 detects the level of the water stored at the bottom of the inner side of the housing 10 and inputted into the water drain passage 33 through the water inflow port 39a of the sealing cap 39 and outputs the detected signal to the controller 90, an operator checks the level of the water to perform an operation of discharging the water through the water discharge port 81 while separated from the water discharge port 8, at the top of the housing 10.

Therefore, the fuel filter 100 for a diesel engine according to various embodiments of the present invention as described above is integrally engaged with the engine body 1 using the mounting bracket 14, such that the fuel filter cannot be damaged due to impact force during an offset collision of the vehicle, thereby enhancing collision safety and collision performance.

In various embodiments of the present invention, since the heater assembly 60 and the water discharge unit 80 are integrally configured as a single module structure at the top of the body 20, the whole structure is simplified, and the size may be compactly implemented.

The fuel filter 100 for a diesel engine according to various embodiments of the present invention is integrally constituted with the engine body 1, and the water discharge unit 80 is provided at the top of the body 20, and as a result, the assembling workability of the whole apparatus 100 may be enhanced, and since the water discharging operation may be performed at the water discharge unit 80, the repairing performance may be enhanced.

Furthermore, in the fuel filter 100 for a diesel engine according to various embodiments of the present invention, the operations of the heater assembly 40 may be controlled by the controller 90 such as an engine ECU by using the fuel temperature sensor 91 which is pre-installed at the engine body 1, as a result, an existing thermo switch may be eliminated.

Therefore, in various embodiments of the present invention, since the existing thermo switch may be eliminated, the structure of the whole apparatus 100 may be simplified, and the number of assembling parts may be reduced, thereby decreasing an assembling defect ratio, manufacturing cost, and weight.

Hereinafter, the operations of the fuel filter 100 for a diesel engine according to various embodiments of the present invention will be described with reference to the accompanying drawings.

First, in various embodiments of the present invention, the fuel supplied from the fuel tank (not illustrated) is inputted into the interior of the housing 10 through the fuel inflow nipple 15 of the head cover 13. At this time, the fuel is inputted from the hollow portion 12 of the filter assembly 11 to the fuel passage 31 of the body 20. The fuel is inputted into the fuel passage 31 through the fuel inlet 37 of the top of the extension 25.

During the above-described procedure, in various embodiments of the present invention, the temperature of the fuel is detected using the temperature sensor 91 which is pre-engaged at the engine body 1, and the detected signal is outputted to the controller 90.

Then, the controller 90 receives the detection signal from the fuel temperature sensor 91 and compares the detection signal with the predetermined reference temperature range of the fuel. When the temperature of the fuel is lower than the reference temperature range, the power and the electric operation signal are supplied to the PTC devices 43 of the heater assembly 40.

The PTC devices 43 generate heat by receiving the power from the connection terminal 47 connected to the connector 29. The generated heat is dissipated through the heat dissipation plates 41 and heats the fuel flowing along the fuel passage 31 to a predetermined temperature.

Here, in various embodiments of the present invention, since the PTC devices 43 are arranged in a zigzag shape at the heat dissipation plates 41 in the longitudinal direction, a heat transfer area for the heat dissipation plates 41 may be increased, and the length of the flow passage of the fuel flowing along the fuel passage 31 can be increased, thereby improving the heat transfer efficiency of the fuel through the heater assembly 40.

Also, in various embodiments of the present invention, the bent portion 49 bent toward the inner wall surface of the fuel passage 31 is formed at the ends of the edges of each of the heat dissipation plates 41, and as a result, the contact area of the fuel flowing in the fuel passage 31 can be improved with respect to the heat dissipation plates 41.

The fuel heated by the heater assembly 40 is discharged from the fuel passage 31 through the fuel outlet 38 formed at the bottom of the extension 25 and passes through the filter assembly 11.

During the above-described procedures, any impurities contained in the fuel are filtered by the filter assembly 11, and the fuel from which the impurities are removed is discharged through the fuel discharge nipple 17 of the head cover 13 and supplied to the side of the engine.

In this case, the fuel from which the impurities are removed by the filter assembly 11 is maintained to be heated by the heater assembly 40, and as a result, the fuel may be supplied to the engine in a non-coagulated state during the winter season.

Meanwhile, during the above-described procedures, in various embodiments of the present invention, the water contained in the fuel is separated from the fuel through the filter assembly 11 due to the difference in viscosity, and the separated water is stored at the bottom of the inner side of the housing 10.

The water stored at the bottom of the inner side of the housing 10 is input to the water into the water drain passage 33 of the body 20 through the inflow port 39a of the sealing cap 39.

Thereafter, the sensor pins 63 of the water sensor 60 detect the level of the water inputted into the water drain passage 33 of the body 20, and the detected signal is outputted to the controller 90 through the circuit substrate 61.

Therefore, in various embodiments of the present invention, it is possible to perform the water discharging operation through the water discharge port 81 on the top of the housing 10 in a state that the drain plug 83 of the water discharge unit 80 is separated from the water discharge port 81 while checking the level of the water through the controller 90.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel filter for a diesel engine, comprising:
a head cover;
a housing which is engaged to the head cover and accommodates a filter assembly;
a body which passes through the head cover and is disposed at the center of the filter assembly; and
a heater assembly which is disposed inside of the body,
wherein the housing is integrally engaged with an engine body, and the heater assembly selectively operates depending on a detection signal of a fuel temperature sensor provided at the engine body.

2. The fuel filter of claim 1, further comprising:
a water sensor which is disposed at the body and configured to detect a level of water separated from diesel fuel.

3. The fuel filter of claim 2, wherein
the body separately forms a fuel passage connected to the filter assembly and a water drain passage connected to a bottom of an inner side of the housing.

4. The fuel filter of claim 3, wherein
the heater assembly is installed at the fuel passage, and
the water sensor is installed at the water drain passage.

5. The fuel filter of claim 3, wherein
a water discharge port is formed at a top of the body and connected to the water drain passage, and
a drain plug is installed at the water discharge port.

6. The fuel filter of claim 1, wherein
the body passes through the head cover and is engaged with the head cover, and
a top of the body is disposed on an upper surface of the head cover.

7. A fuel filter for a diesel engine, comprising:
a head cover;
a housing which is integrally engaged with an engine body and engaged to the head cover and accommodates a filter assembly;
a body separately forming a fuel passage which passes through the head cover and is installed at a center of the filter assembly and partitions the filter assembly and a water drain passage connected to a bottom of an inner side of the housing;
a heater assembly which is installed at the fuel passage of the body;
a water sensor which is installed at the water drain passage of the body and is configured to detect the level of water separated from diesel fuel; and
a water discharge unit which is disposed at a top of the body so as to discharge the water input into the water drain passage.

8. The fuel filter of claim 7, wherein
the body is integrally formed with the heater assembly, the water sensor, and the water discharge unit as a single module structure.

9. The fuel filter of claim 7, wherein
an engaging portion which supports the heater assembly and the water sensor and forms the water discharge unit is provided at the top of the body.

10. The fuel filter of claim 7, wherein
the head cover includes:
a fuel inflow nipple configured to enable the diesel fuel to flow into the filter assembly; and
a fuel discharge nipple which discharges the diesel fuel from water and impurities which are removed through the filter assembly.

11. The fuel filter of claim 7, wherein
the body separately forms, at a hollow portion of an inside of the body, a fuel passage and a water drain passage each having a semi-circular cross-section and formed through a partition wall.

12. The fuel filter of claim 7, wherein
the heater assembly includes:
a pair of heat dissipation plates installed at the fuel passage; and
a plurality of Positive Temperature Coefficient (PTC) devices which are arranged between the pair of the heat dissipation plates and engaged to the heat dissipation plates using engaging bolts.

13. The fuel filter of claim 12, wherein
the PTC devices are arranged in a zigzag shape in a longitudinal direction of the heat dissipation plates.

14. The fuel filter of claim 13, wherein
both ends of each heat dissipation plate in the longitudinal direction of the body are bent toward an inner wall surface of the fuel passage.

15. The fuel filter of claim 12, wherein
an engaging portion which supports the heater assembly and the water sensor and forms the water discharge unit is provided at the top of the body, and
a connector which is connected to the PTC devices as an electric signal system is installed at the engaging portion.

16. The fuel filter of claim 9, wherein
the water sensor includes:
a circuit substrate installed at the engaging portion; and
at least one sensor pin which is connected to the circuit substrate and fixed at the engaging portion, and disposed at the water drain passage.

17. The fuel filter of claim 7, wherein
the water discharge unit includes:
a water discharge port which is formed at the top of the body and connected to the water drain passage; and
a drain plug which is installed at the water discharge port.

18. The fuel filter of claim 17, wherein
an engaging portion which supports the heater assembly and the water sensor and forms the water discharge unit is provided at the top of the body, and
the water discharge port is integrally formed at the engaging portion.

19. The fuel filter of claim 17, wherein
a sealing cap which passes through a water input portion connected to the water drain passage and seals the fuel passage is installed at a bottom of the body.

20. The fuel filter of claim 7, wherein
the heater assembly selectively operates according to a detection signal of the fuel temperature sensor disposed at the engine body.
